(19) United States
(12) Patent Application Publication
(10) Pub. No.: US 2014/0110021 A1
(43) Pub. Date: Apr. 24, 2014

(54) Robotic Tree Trimmer And Cutter

(71) Applicant: David H. Divine, Great Barrington, MA (US)

(72) Inventor: David H. Divine, Great Barrington, MA (US)

(21) Appl. No.: 14/058,891

(22) Filed: Oct. 21, 2013

Related U.S. Application Data
(60) Provisional application No. 61/717,907, filed on Oct. 24, 2012.

(51) Int. Cl. A01G 23/095

(52) U.S. Cl. CPC A01G 23/0955; Y10S 901/01
USPC 144/24.13; 901/1

(57) ABSTRACT

A train like vehicle composed of a plurality of interconnected cars (e.g. about 25 cm in length) linked together with springs and cables making it flexible. The shape and tension of the unit will be altered by remote control or an autonomous response system enabling steering and ability to grab on to various shapes of tree trunks and branches. The cars will be equipped with drive wheels that will move the vehicle. The device is configured to include a rotating turret capable of turning in a 360-degree circular motion, and a turret attached to the belly of the front car that is configured to roll 180 degrees back and forth. A hinge after the turret may be provided to give it more angle and flexibility to hold a chainsaw.

### RELATED APPLICATION

This application claims the benefit of U.S. Provisional Application No. 61/717,907, filed on Oct. 24, 2012. The entire teachings of the above application are incorporated herein by reference.

### BACKGROUND

Technologies exist that can aid a user in cutting and pruning branches on a tree. Such conventional approaches can be dangerous to the user. While many tree limb cutting/pruning devices are handheld devices, various automatic chainsaws and other motorized devices exist to aid a user in such cutting. For example, there are pruning devices that use a chainsaw with a flexible chain bar that can wrap around the trunk of a tree. The chainsaw chains may have articulated links so that the chain can curve about one lateral axis to form an endless chain and so that it may follow the track in the chain bar.

### SUMMARY

Conventional approaches to cutting or pruning branches typically do not enable a user to effectively cut with precision in a safe and cost effective manner. To prune branches with precision, users typically have to cut branches using handheld devices. With such handheld devices, the user often has to go up in a tree or be in a bucket truck, which can be dangerous to the user. While conventional automated approaches may not necessarily be as dangerous as handheld devices, typically such automated approaches do not enable a user to cut with precision. Further, such automated approaches generally do not have the ability to selectively cut branches in that they cannot avoid certain branches in their path, while cutting others in their path. The inability to provide selective cutting and pruning of branches using an automated cutting device prevents the cutting device from operating with selective precision. Moreover, conventional automated approaches are often harmful to the tree.

Thus, it may be desirable to provide an automated remotely operated tree cutting device that is capable of operating with precision, capable of selectively cutting certain branches while circumventing branches that a user would like to keep, and capable of maintaining the health of the tree. An automated tree cutting device according to certain embodiments of the invention is capable of addressing such issues in a safe and effective manner.

Aspects of the invention relate to an automated approach/tool that enables users to cut or prune tree branches without having a user go up in the tree or have to be in a bucket truck. The automated tool may be used to cut down the entire tree. The automated tool can be remotely controlled by a user, while it is in use high in the tree. Having the remote capabilities, the inventive cutting tool is capable of functioning with great control and stability without being blind to the health of the tree. The inventive tool is flexible enough to enable it to adapt and change shape in order to accommodate different kinds of trees.

The inventive tool may include a remote controlled saw that may be driven up the tree by means of remote control with rechargeable battery power. In another embodiment, the inventive tool may be outfitted with a gasoline engine. It may regenerate and recharge the batteries by means of a gasoline chainsaw engine. It may also have an electric power cord.

This inventive tool may include properties of a snake and properties of a wheel driven vehicle. Motors can drive the wheels. The snakelike coil tension can be controlled by motor and spring tension called the “flex actuator”. The tension created by two screws drives on cables may be controlled by a spring through levers pulling the vehicle into a coil shape position around a tree in order to hold tightly to the tree. The steering may be controlled by to two screw drive motors that would move it either left or right or up or down up the tree. The saw may be held in place by a rotating turret assembly, which will rotate around the belly of the front car.

The saw portion of the tool has an inventive configuration in that the angle is configured with rotating rollers in the blade to feed it into the wood.

The present invention can also provide an automated cutting device for use in trees, which can include a plurality of interconnected car units capable of being wrapped around a trunk of a subject tree in a snake/spiral coil like configuration. The plurality of interconnected car units can be arranged to navigate up a subject tree such that the interconnected car units wrap around a trunk or branch of the tree in a spiral/snake like configuration. The plurality of interconnected cars can be linked together with tension cables and can use springs and electric motor (flex) actuators to provide steering capabilities. A robotic arm can be coupled to the plurality of interconnected car units. A chainsaw with a bar can be configured to prevent a jam when the weight of a respective branch of the tree rests on it. The robotic arm can be configured to hold the chainsaw, as well as to move the chainsaw in a first direction up to about 360 degrees relative to a longitudinal axis of the interconnected car units, and to move the chainsaw in a second direction up to about 180 degrees parallel to the interconnected car units. A computerized remote control device can be configured to control the interconnected car units, robotic arm, and/or the chainsaw including movement control and cutting control. Branch deflecting rollers can be coupled to at least a front exterior portion of the plurality of interconnected car units.

The present invention can also provide a robotic tree cutter including a string of car-like units able to move up a tree and steer around branches, and able to spiral up the outside of a tree like a snake. A chainsaw can be included with a bar that does not jam when the weight of a tree branch rests on it. A computerized remote control device can be included. A robotic arm attachment can hold the saw which can move the saw 360 degrees relative to a longitudinal axis of the car-like units and 180 degrees parallel. Branch deflecting rollers can be mounted on the front of the car-like units.

In particular embodiments, the string of car-like units can be steered using tension cables controlled by springs and electric motor actuators called flex actuators. The steering configuration can include the flex actuators configured to control the arch of the car-like units from left to right and from up to down or all directions. The flex actuators can include motors, gears and worm drives pulling a shaft holding the cables. The string of car-like units can be arranged to spiral up a tree using a rotating motor between each car giving it the ability to twist. The car-like units can include arch-shaped boxes capable of wrapping around the tree. The car-like units can drive on wheels turned by worm drive motors. The wheels can include at least two wheels, one on each side of one or more of the car-like units, such that they are located on a front, rear position or middle position of each car-like unit. The string of car-like units can be in a snake like configuration such that it is configured to mimic the motions of a snake. The chainsaw can be configured to avoid jamming by including a chainsaw bar that has rollers embedded in it driven by flat gears in the metal. The computerized remote control device can be configured to include computer readable instructions executed by one or more processors in an electronic controller. The computer readable instructions can be configured to control the robotic tree cutter. The computer readable instructions can be configured to activate the motors and actuators on the robotic tree cutter, including the speed of the saw, the actions of the robotic arm, and the actions of the car-like units. The actions of the robotic arm and the car-like units include actions controlled by the remote control and/or by autonomous software. The autonomous software can be driven by sonar sensors mounted to at least one of the front of the front car-like unit and the top of the front car-like unit and on the rear car-like unit. The robotic arm can be configured to hold the saw and move the saw. The robotic arm can include a rotating collar that wraps around the first car-like unit, and a rotating turret that holds a hinge, all activated by electric motors and gears. The branch deflecting rollers can include at least two rollers coupled to or mounted from top to bottom on the front of the string of car-like units, such that they are arranged to turn in opposite directions in order to force the robotic tree cutter away from any obstructing branches.

The present invention can also provide a tree climbing apparatus including a head segment with a centerline having a propulsion unit for engaging a tree and providing propulsion in the direction of the centerline of the head segment. A series of body segments and a tail segment can be serially connected behind the head segment. A series of segment joints can connect the head segment to a following body segment, connect subsequent body segments to each other, and connect the tail segment to a last body segment. A joint control system can resiliently position the head, body and tail segments in a generally serpentine gripping position around a tree. The propulsion unit of the head segment in combination with the joint control system can propel the true climbing apparatus up the tree with the head segment moving in the direction of the centerline of the head segment, with the body and tail segments following in a generally serpentine manner.

In particular embodiments, a saw can be attached to the head segment. The propulsion unit can include drive wheels and the body and tail segments can include rollable wheels, for engaging the tree. The joints can include springs, which allow at least one of bending of the segments relative to each other, movement towards and away from each other. A spring loaded cable system can provide the segments with a generally serpentine resilient gripping ability.

The present invention can also provide a method of cutting at least portions of a tree, including providing a robotic arm coupled to a plurality of interconnected cars that are interconnected using tension cables. The robotic arm can be configured to facilitate cutting a branch of a tree or the trunk of the tree. The interconnected cars can be configured with branch deflecting rollers. The interconnected cars can be configured to wrap about at least a portion of the tree such that they are wrapped around in a spiral like configuration. A remote control device can be configured to provide cutting instructions to one or more processors controlling movement and motion of the robotic arm and the interconnected cars.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A and 1B show an embodiment of the invention stretched out, in side and top views, as it is when it is stretched out or not in use. This shows it being similar to a train composed of cars. Here the flex actuation is relaxed and is ready to install on a tree.

FIGS. 2A and 2B show an embodiment of the invention in action as it is climbing a tree with the attached chainsaw. This shows the invention in a positive flex mode where it is tightening itself around a tree trunk, ready to prune a branch.

FIGS. 3A and 3B show an embodiment of a front car that holds the chainsaw. It also shows how it holds the saw and how the motors, gears and electronics can be configured. It shows how there will plenty of space for batteries and motors in its elongated design. The drawing of an embodiment of a tail car shows the flex actuator which will drive cables against spring tension in order to flex the cars either left or right or downwards in order to wrap itself around a tree.

FIGS. 4A and 4B are schematic drawings, which show the chainsaw and the feeder roller arrangement that can help in the case that a limb or branch pinches the blade.

FIG. 4C is a schematic drawing of a screw device attached to a cable.

FIGS. 4D and 4E are perspective views of a portion of an embodiment of cars at a partial stage of assembly.

FIG. 5 is a schematic illustration of a computer network or similar digital processing environment in which embodiments of the present invention may be implemented.

FIG. 6 is a block diagram of the internal structure of a computer of the network of FIG. 5.

### DETAILED DESCRIPTION OF THE INVENTION

A description of example embodiments of the invention follows.

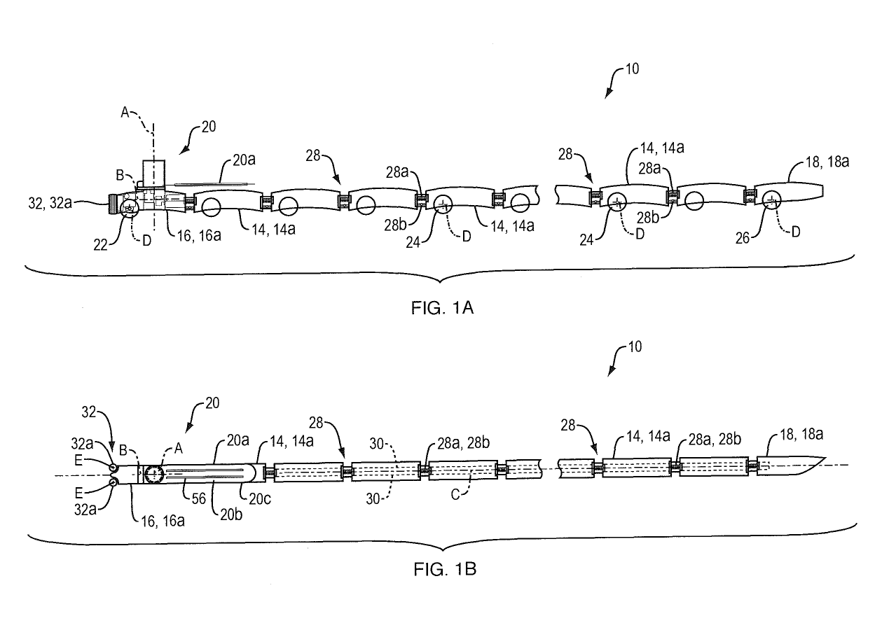

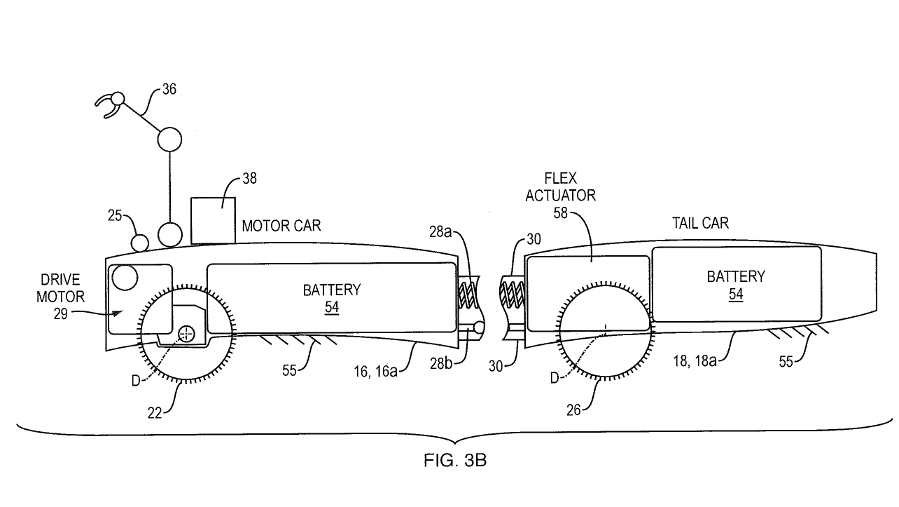

Embodiments of this automated, robotic or remote controlled saw, or tree climbing, climber, cutter or cutting device, tool or apparatus 10 (FIGS. 1A-4B), can be driven up a tree 12 by means of remote control with rechargeable battery power shown in the design in FIG. 3B. With the availability of highly efficient batteries, the climber cutter device 10 can run for a certain amount of time on batteries or can be outfitted with a gasoline engine. Regeneration and recharging of the batteries can be performed with a gasoline chainsaw engine and generator. The means of power can be by rechargeable battery, and the device 10 can be fitted with rechargeable battery packs.

Embodiments of the tree climbing cutting device 10 can include a series of jointed, flexible, movable, articulating, constricting or constrictable members, links, segments or cars 16, 14 and 18 serially connected together by pivots, hinges or joints 28 in a chain, sequence or series, in a serpentine, snake or snakelike configuration. The distance between the cars 16, 14 and 18 can be controlled, and/or the lontigudinal axis or centerline C of each or all of the cars, for curving, constricting and moving around a tree 12. The cars can include a first, lead, head, front, motor, cutter, cutting or roller, member, link, segment or car 16, a series or number of connection, connecting, support torso, body, intermediate, or roller members, links, segments or cars 14, and a second, end, rear or tail, roller member, link segment or car 18.

The head drive car 16 can have a front drive motor 29 for driving a pair of front drive or movable members, rollers or wheels 22 about an axis D that can be laterally transverse or orthogonal to centerline C of car 16, for driving the device 10 up and/or around a tree 12. The front end or tip of car 16 can have a branch or obstacle deflector 32 having two wheels or rollers 32a that are spaced apart from each other and driven by a deflector motor drive 34 about respective axes E. The axes E can be orthogonal to both the centerline axis C of the car 16 and the rotational axes D of wheels 22, which can help direct the car 16 laterally or to the side of obstacles such as branches 12a, by engaging and rolling or driving around the obstacles.

The head car 16 can include a saw 20, such as a chain saw, attached, connected to or integrated with the car 16. The saw 20 can include an elongate saw blade 20a having an elongate bar 20b, and an endless moving chain saw cutting chain 20c, that travels around the periphery or edge of the bar 20b. The saw blade 20a can be attached to a turret 42, and chain 20c can be driven by a saw motor 40 that is housed within the turret 42. The turret 42 can be connected to a rotating or rotatable collar or section 44, that is attached, connected to, wrapping around or integrated with car 16, such as at a center or mid section. The turret 42 can be rotated 360 degrees by a turret motor 46 about a swinging or pivoting hinge or joint around an axis A that is transverse or orthogonal to the saw blade 20a and centerline C. This can orient or position the saw blade 20a and rotate, swing, move or pivot the saw blade 20a while cutting branches 12a. The rotatable section 44 can be rotated, swung, pivoted or moved 180 degrees by motor 48 about axis B, which can be on or parallel to centerline C of car 16, and can be orthogonal to axis A. Rotating, moving, swinging or pivoting about the two axes A and B, can orient the saw blade 20a in the desired position to cut selected branches 12a. Saw 20, turret 40 and section 44, or portions thereof, can be considered a robotic arm, and the motors can include reduction or worm gears. Further positioning can be achieved by steering car 16 on the tree 12 relative to the branch 12a.

Operation of device 10 and its motors can be controlled by electronics 50 housed within the housing 16a of car 16. The electronics 50 can include a transmitter and/or receiver 52 for allowing the operator to control or monitor device 10. The transmitter and/or receiver 52 can be connected to a remote control or monitor 80 by a cable or by wireless. A battery 54 can be housed within the housing 16a of car 16 for providing power to some or all of the motors and electrical components in car 16 and/or device 10.

A number of cars 14 can be movably connected between the head car 16 and the tail car 18 by joints 28. Each joint between cars 16, 14 and 18 can include a spring member 28a, such as a coil spring, which can compress, stretch, and/or bend, for allowing the distances between the cars 16, 14 and 18 to be varied towards or away from each other, and/or the orientation (such as pivoting, bending or curving) relative to each other. A series of control cables 30 can extend from the tail car 18, through the intermediate cars 14 and to the head car 16, for steering, controlling, loosening, bending, tightening or constricting the cars 16, 14 and 18 on or around a tree 12. Some embodiments can have four cables 30 surrounding spring member 28a, above, below and on two opposite sides. In some embodiments, each joint 28 can have a hinge joint 28b between each car 16, 14 and 18, which can provide bending at predictable locations between the cars. The hinge joints 28b can include a ball joint for bending or pivoting at all various multiple angles, or can include more restrictive joints that limit bending to certain desired directions, axes or planes. Hinge joint 28b can be adjacent to spring member 28a, or can be position coaxially within spring member 28a. Hinge member 28b can have a sliding joint for accommodating changes in distances between the cars 16, 14 and 18.

Each car 14 can have a housing 14a with a pair of movable members, rollers or wheels 24 rotatable about an axis D, mounted thereto, for rotatably engaging the tree 12, which can provide the device 10 with forward locomotion, as well as constrictional hugging, holding, gripping, or frictional gripping or retainment, to prevent the device 10 from sliding down a tree trunk. The more cars 14 that are used with device 10, the more resistance to slipping down a tree 12, or higher or increased gripping can be obtained. The housings 14a, 16a and 18a of cars 14, 16 and 18 can have arched or curved belly or bottom surfaces for curving around a tree 12. The back surfaces can also be curved. In one embodiment, device 10 can have nine intermediate cars 14. Other embodiments can have more than nine or less, depending upon the application at hand, and the size of the tree 12. Some or all of the cars 14 can be driven, as in car 16, or can be idlers.

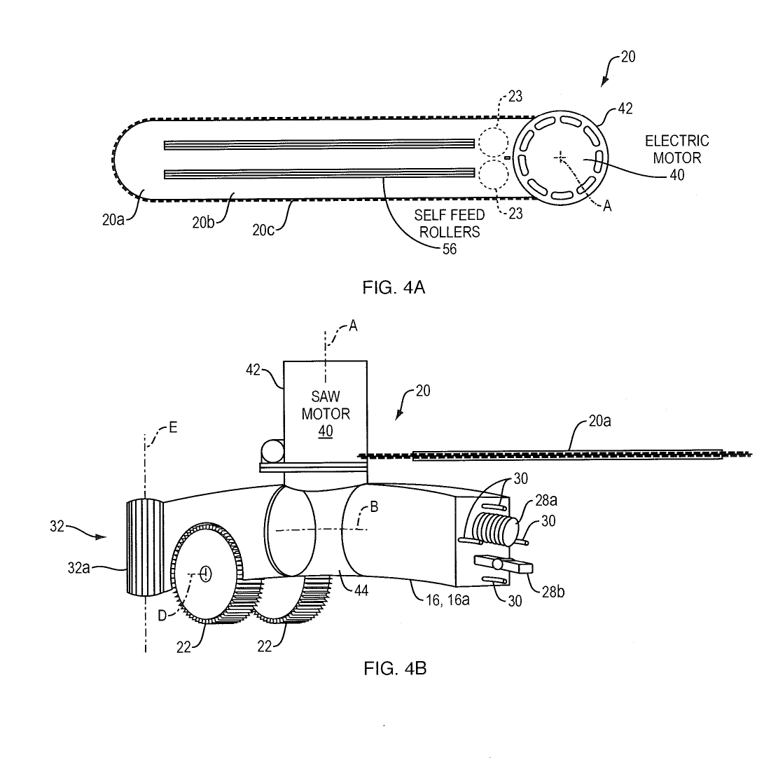

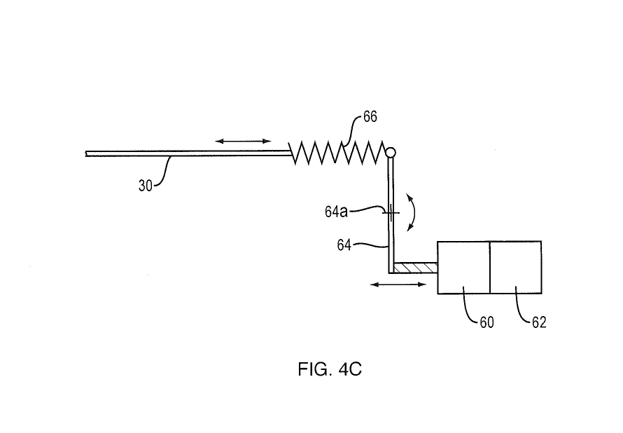

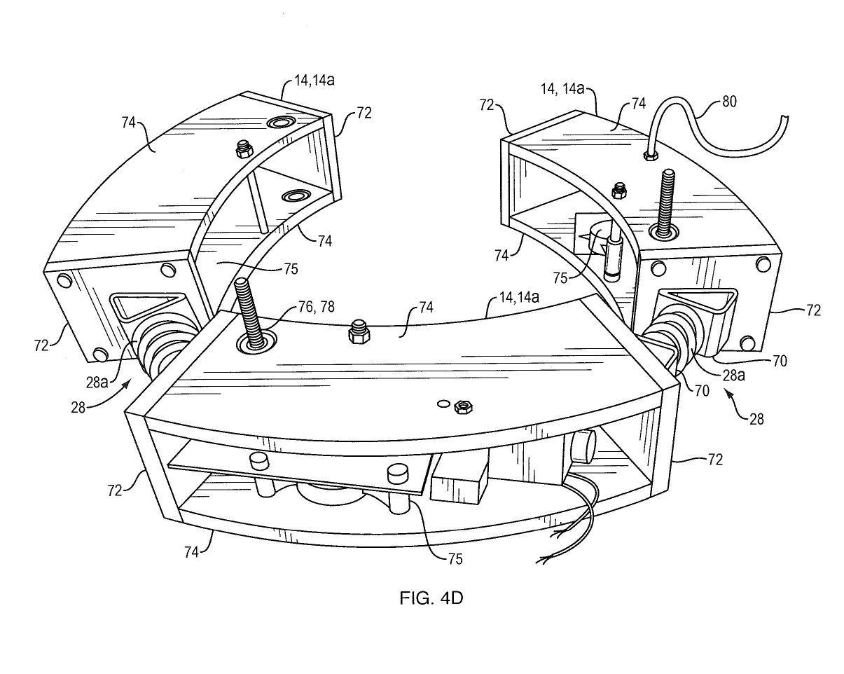

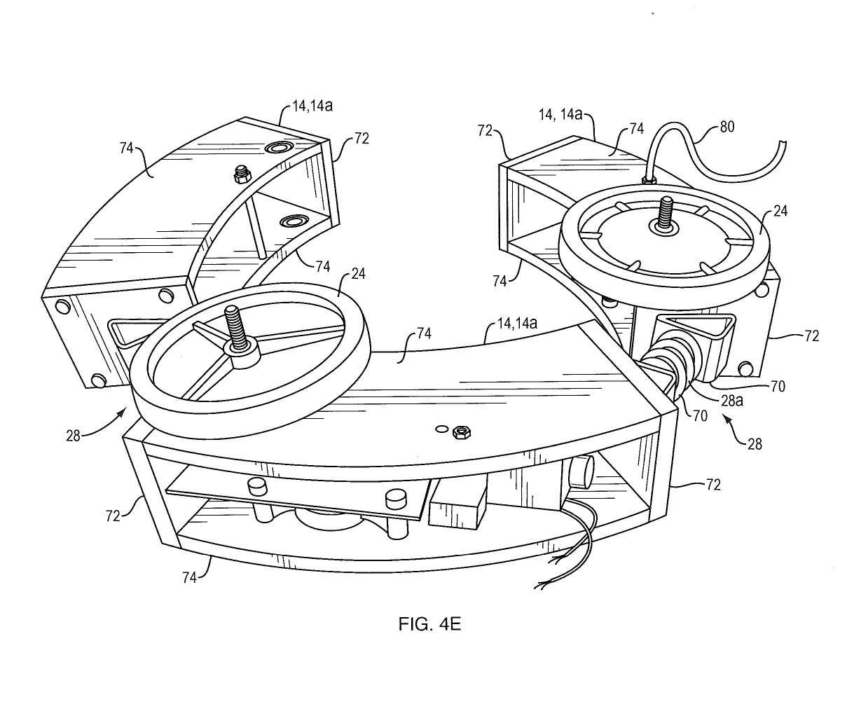

The tail car 18 can have a housing 18a to which a pair of movable members, rollers or wheels 26 can be rotatably mounted about an axis D. The housing 18a can also contain a flex actuator 58 and a battery 54 for providing power to the flex actuator 58, if needed. Referring to FIG. 4C, the flex actuator 58 can have an actuator such as a screw device or drive 60 that can be driven by a motor 62 for extending or retracting each cable 30 via a lever 64 that pivots about axis 64a and a spring 66 connected therebetween. The screw device 60 and/or motor 62 can include gears and/or worm drives. Two screw devices 60 can be adjusted to adjust certain cables 30 to tighten or wrap the cars 16, 14 and 18 around the tree 12, and two other screw devices 60 can be adjusted to adjust certain cables 30 to turn the cars 16, 14 and 18 left or right. Adjusting the cables 30 with the flex actuator 58 can tighten the cars 16, 14 and 18 around the tree trunk in a generally spiral, coil, helical or serpentine configuration, for suitable snake or serpentine constrictional gripping, hugging, holding and/or frictional gripping. The springs 66 can allow the cables 30 to have resilient give, to elastically or resiliently conform or stretch to variations in tree surface shapes to allow resilient or elastic gripping around the tree 12 and/or aid in locomotion. In some embodiments, the shaft of the screw device 60 can be coupled to spring 66 without lever 64 therebetween. The flex actuator 58 can have other suitable designs, including the use of spools, pulleys, rotary actuators, pistons, solenoids, etc. In some embodiments, tail car 18 can also have a motor drive for driving wheels 26 for added driving capability , and some or all cars 14 can also have drive wheels driven by a motor. The motor drives can include worm drives. In other embodiments, more than one flex actuator 58 can be used to tighten the cars 16, 14 and 18, for providing different constriction or bending characteristics at different or separate longitudinal sections.

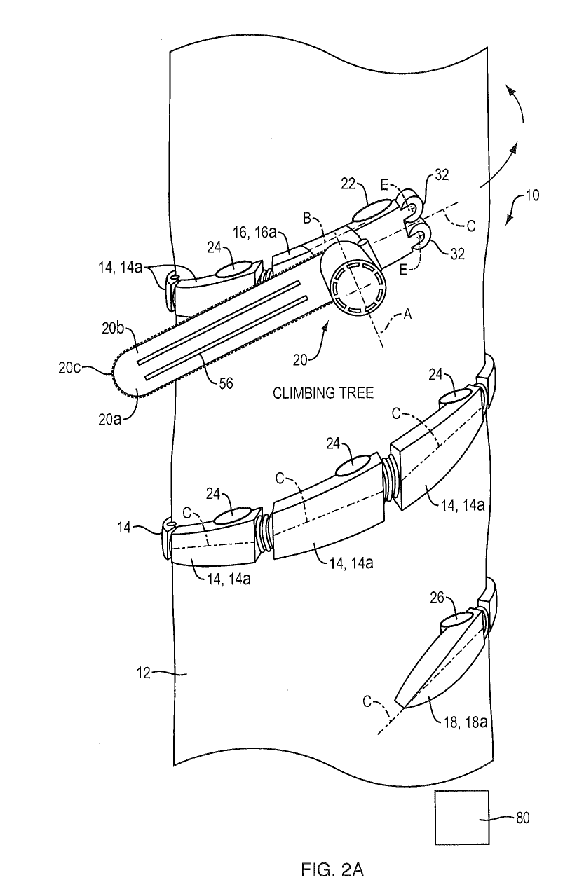

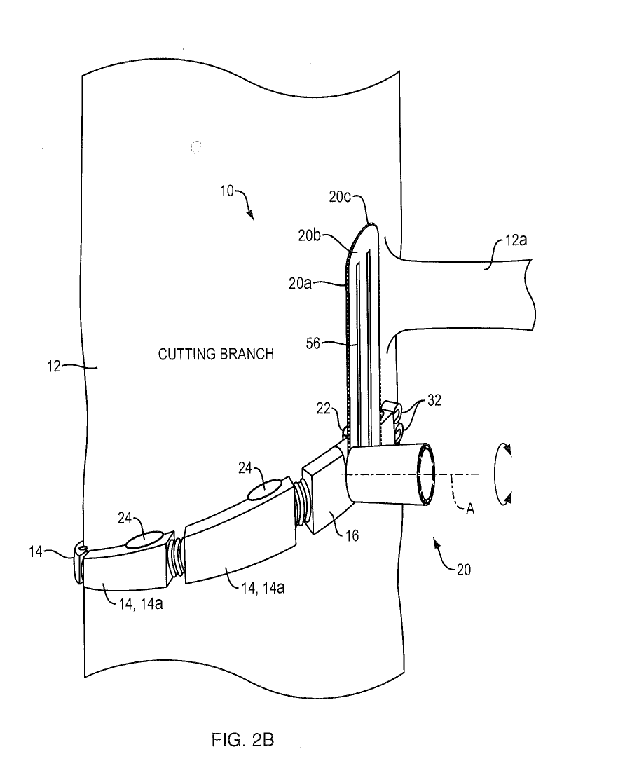

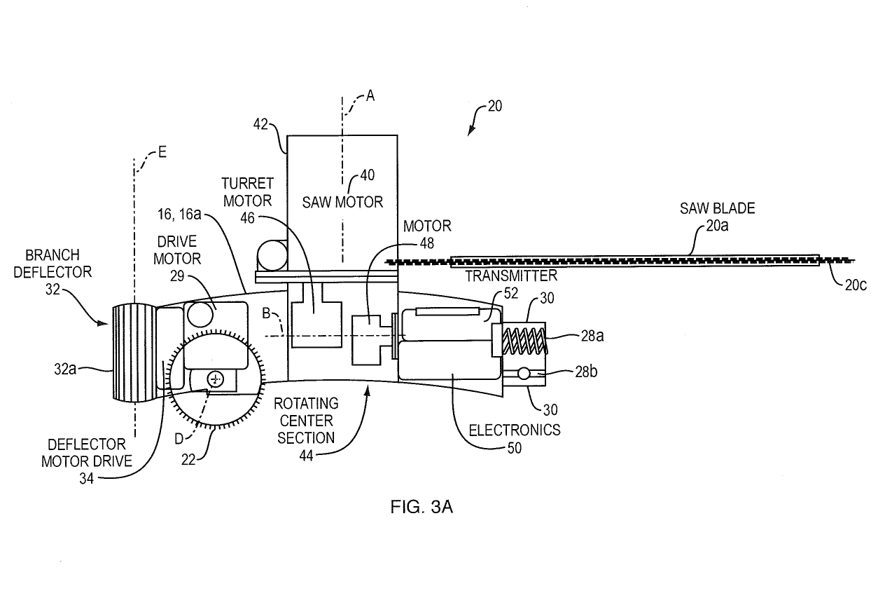

The device 10 can have similar properties of a snake and properties of a wheel driven vehicle where motors can drive the wheels. The snakelike coil tension can be controlled by motor and spring tension called the “flex actuator” 58. For example, the cars 16, 14 and 18 of device 10 can be constricted or tightened around a tree 12 in a generally spiral, helical, coil, snake or serpentine configuration as shown in FIG. 2A, by the flex actuator 58 to provide constrictional gripping, hugging, holding or frictional gripping. The drive wheels 22 of the head car 16 can guide, drive and/or pull the trailing cars 14 and 18 around and up the tree 12 in a helical, coil, spiral, snake or serpentine path, moving forwardly in the direction of centerline C of the cars 16, 14 and 18, as indicated by the arrows. Selected cars 14 and 18 can also be driven, if desired. In some cases, the flex actuator 58 can be cyclically operated to cyclically loosen and constrict or tighten the cars 16, 14 and 18, or selected cars thereof, to enhance climbing up the tree 12 while head car 16 drives. Climbing onto branches 12a can also be accomplished in a similar manner. The cables 30 can be adjusted to tighten or orient the cars 16, 14 and 18 as required to adjust to tree conditions. Spring members 28a can also provide resilient adjustment or compensation while on the tree 12. In some embodiments, some or all of cars 16, 14 and 18 can have the wheels omitted, and merely provide constrictional hugging, holding or gripping, frictional gripping and/or sliding segments. In such an embodiment, the cars 16, 14 and 18 can have hairs, ridges, scales, structures or surfaces 55 (FIG. 3B), that allow forward movement but resist or prevent backward movement. Such surfaces 55 can also be included in addition to wheels on cars 16, 14 and 18. In some embodiments, all the cars 16, 14 and 18, or selected cars thereof, can be driven. The head car 16 can be actuated or driven first, and the following driven cars 14 and 18 can be actuated or driven subsequently, and sequentially in short pulses, starting and stopping, to drive device 10 around and up the tree 12 in serial start/stop sequence. The joints 28 between each car can be allowed to expand and contract in the start/stop sequence to allow moving cars to be moved relative to the proceeding and following stopped cars. In some embodiments, some of or all of the cars can brake their respective wheels if desired. In some embodiments, the head car 16 can be the head driven car, and undriven cars, segments or members can be in front of car 16, such as to hold or position saws, tools, cameras, sensors, etc. When climbing down the tree 12, the device 10 can operate in reverse, traveling tail car 18 first, or can drive down head car 16 first.

The saw 20 can include an inventive configuration in that the angle of the saw 20 might not always be conventionally correct or it may jam so the saw 20 can have rotating rollers 56 in the blade 20a to feed it into the wood. The rollers 56 can be embedded or positioned in or on the bar 20b of the saw blade 20a and extend from opposite faces, each in two parallel lines or rows to prevent the saw blade 20a from being pinched by a branch 12 and stalling the movement of chain 20c. The rollers 56 can be a series of rollers and can be driven by motor 40, with flat gears 23 in the metal of the bar 20b, or can be idler rollers.

The device 10 can be configured to attach to any size or shape of tree 12 and be able to climb it without damaging it. It can be configured to run on batteries or gasoline. Some embodiments can hold other tools other than a chainsaw.

The device 10 can attach a rope (or other suitable system) to the top of the tree to provide a failsafe measure in the event it dislodges from the tree. Example possibilities can include one or more robotic arms 36 (FIG. 3B) that can tie a knot around the tree 12, putting an anchor in the tree 12 using small detonator, or having the device 10 hold an anchor rope that could be shot down to the ground.

The wheels 22, 24 and 26 on the cars 14, 16 and 18 can preferably be rubber or a similar composition in order to grip the trees 12. Wheels 22 of car 16 can be driven in order to steer the car 16 around tree 12. In some embodiments, the wheels or drive wheels can be made of suitable metals or alloys, including steel, titanium, aluminum, etc., or alloys thereof. In addition, the wheels can be made of further suitable materials, including plastics, polymers, composites, etc.

The deflector rollers 32a can be used on the front of car 16 in one exemplary embodiment. The deflector rollers 32a can help enable the device 10 to circumvent branches. A sensor, software and robotic movement may be used in another embodiment. The position of the wheels may vary depending on the way that the vehicle is applied.

This design may also use a helix shape. The helix shape can be used in order to have device 10 climb the tree 12 while holding the saw 20; rather than having a saw that can take a helix shape. In some embodiments, a helical saw can be used if desired.

Conventional technologies that provide automated pruning and/or cutting functions are not as easy to install to the tree in contrast to the present invention. Unlike certain embodiments of the present invention, the automated conventional technologies typically have to encompass the entire tree trunk. They are unable to circumvent branches that a user may want to leave in place, while cutting others, and they cannot adapt to extremely large, very small or misshapen trees.

Aspects of the inventive tool may also be fitted with a camera 38 (FIG. 3B) so the operator can see the work and the path that the device 10 is performing. The device 10 may be given some autonomous actions. It can be programmed to drive up the tree 12 while the operator simply picks what branches they want trimmed while the device 10 steers itself around branches. The device 10 may be able to learn angles and directions that the saw 20 would need to be held. Sensors such as sonar sensors 25, can be mounted to the front, or top of car 16, or to car 18 for providing guidance to device 10.

In some embodiments, referring to FIGS. 4D and 4E, the housing 1a of cars 14 can have two side walls, plates or members 74 and two end walls, plates or members 72. The spring members 28a can be connected between angled brackets 70 on the end walls 72, which can promote a curved orientation of the cars 14 relative to each other. Axles 76 can extend through the side walls 74 and can be supported by bearings 78. Wheels 24 can be mounted to the axles 76. Electrical power and/or control cables 80 can extend through the connected cars 14 and around or through the spring members 28a.

In some embodiments, each car 14 can include a motor drive 75 for driving the wheels 24 of each car 14, and/or include a rotating motor or motor drive positioned or acting between each car 14 for providing the ability to twist. In other embodiments, some selected cars 14 can include a motor drive 75. Some or all selected cars 14 can also include batteries.

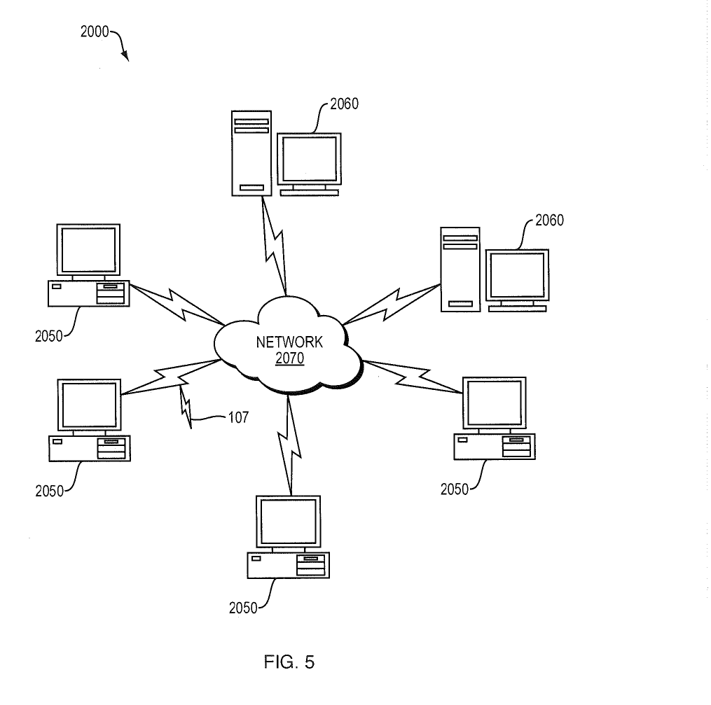

FIG. 5 illustrates a computer network or similar digital processing environment 2000 in which components of the robotic tree cutter (the inventive tool) of the present invention may be implemented. Client computer(s)/devices 2050 and server computer(s) 2060 can provide processing, storage, and input/output devices executing application programs and the like. Client computer(s)/devices 2050 can also be linked through communications network 2070 to other computing devices, including other client devices/processes 2050 and server computer(s) 2060. Communications network 2070 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

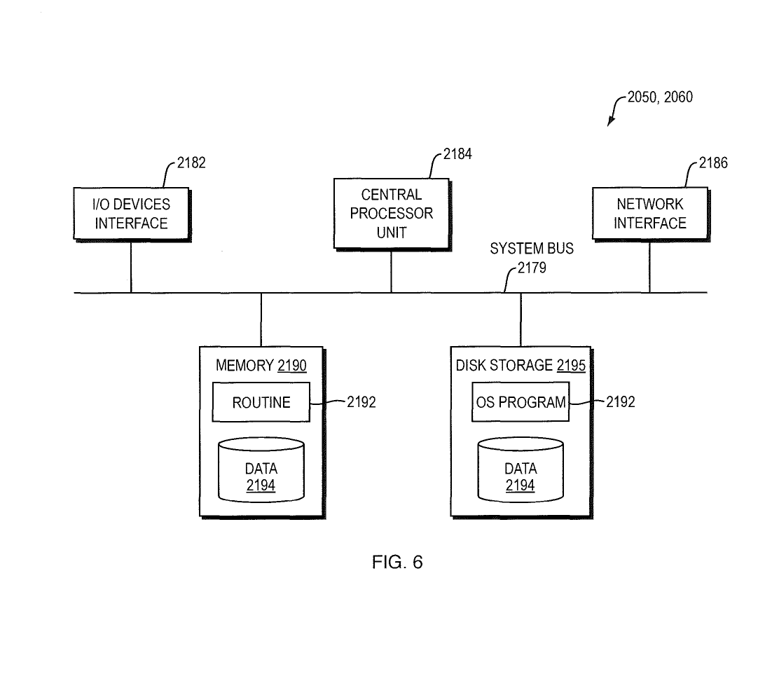

FIG. 6 is a diagram of the internal structure of a computer (e.g., client processor/device 2050 or server computers 2060) in the computer system of FIG. 5. Each computer 2050, 2060 can contain system bus 2179, where a bus is a set of hardware lines used for data transfer among the components of a computer or processing system. Bus 2179 is essentially a shared conduit that connects different elements of a computer system (e.g., processor, disk storage, memory, input/output ports, network ports, etc.) that enables the transfer of information between the elements. Attached to system bus 2179 is an Input/Output (I/O) device interface 2182 for connecting various input and output devices (e.g., keyboard, mouse, displays, printers, speakers, etc.) to the computer 2050, 2060. Network interface 2186 allows the computer to connect to various other devices attached to a network (e.g., network 2070 of FIG. 5). Memory 2190 provides volatile storage for computer software instructions 2192 and data 2194 used to implement an embodiment of the present invention (e.g., remote control instructions, cutting instructions, sensor feed back). Disk storage 2195 provides non-volatile storage for computer software instructions 2192 and data 2194 used to implement an embodiment of the present invention. Central processor unit 2184 can also be attached to system bus 2179 and provide for the execution of computer instructions. In some embodiments, the remote control 80 can be an input/output device.

In one embodiment, the processor routines 2192 and data 2194 are a computer program product, including a computer readable medium (e.g., a removable storage medium, such as one or more DVD-ROM's, CD-ROM's, diskettes, tapes, hard drives, etc.) that provides at least a portion of the software instructions for the invention system. Computer program product can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium 107 (e.g., a radio wave, an infrared wave, a laser wave, a sound wave, or an electrical wave propagated over a global network, such as the Internet, or other network(s)). Such carrier medium or signals provide at least a portion of the software instructions for the present invention routines/program 2192.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product is a propagation medium that the computer system may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims

For example, while aspects of the invention, such as the robotic arm are described such that the saw can be configured to move/rotate in 360 degrees longitude to the interconnected car-like unit and 180 parallel to the interconnected car-like unit, other degrees of motion may be used. Further, while the interconnected car-like unit is preferably about 25 cm in length, any length may be used in implementation such that it facilitates adequate wrapping around the tree. Various features described can be omitted or combined together. In some embodiments, the cars can have other suitable drive devices and can include tractor belts or walking legs or members.

Further, the remote control features of the present invention may be implemented in a variety of computer architectures known to those of ordinary skill. The computer network of FIGS. 5 and 6 are for purposes of illustration and not limitation of the present invention.

The invention can take the form of an entirely hardware embodiment, an entirely software embodiment or an embodiment containing both hardware and software elements. In one preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Some examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code are retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. An automated cutting device for use on trees, the automated cutting device including:
a plurality of interconnected car units capable of being wrapped around a trunk of a subject tree in a snake/spiral/coil like configuration, the plurality of interconnected car units arranged to navigate up a subject tree such that the interconnected car units wrap around a trunk or branch of the tree in a spiral/snake like configuration;
the plurality of interconnected car units being linked together with tension cables, the plurality of interconnected cars using springs and electric motor (flex) actuators to provide steering capabilities;
a robotic arm coupled to the plurality of interconnected car units;
a chainsaw with a bar configured to prevent a jam when the weight of a respective branch of the tree rests on it;
the robotic arm configured to hold the chainsaw, the robotic arm being configured to move the chainsaw in a first direction up to about 360 degrees relative to a longitudinal axis of the interconnected car units;
the robotic arm configured to move the chainsaw in a second direction up to about 180 degrees parallel to the interconnected car units;
a computerized remote control device configured to control the interconnected car units, robotic arm, and/or the chainsaw including movement control and cutting control; and
branch deflecting rollers coupled to at least a front exterior portion of the plurality of interconnected car units.

2. A robotic tree cutter comprising:
a) a string of car-like units able to move up a tree and steer around branches, and able to spiral up the outside of a tree like a snake;
b) a chainsaw with a bar that does not jam when the weight of a tree branch rests on it;
c) a computerized remote control device;
d) a robotic arm attachment to hold the saw that can move the saw 360 degrees relative to a longitudinal axis of the car-like units and 180 degrees parallel; and
e) branch deflecting rollers mounted on the front of the car-like units.

3. The robotic tree cutter as in claim 2 wherein said string of car-like units is able to steer using tension cables controlled by springs and electric motor actuators called flex actuators.

4. The robotic tree cutter as in claim 2 further including a steering configuration including:
said flex actuators configured to control the arch of the car-like units from left to right and from up to down or all directions;
said flex actuators including motors, gears and worm drives pulling a shaft holding the cables.

5. The robotic tree cutter as in claim 2 wherein said string of car-like units is arranged to spiral up a tree using a rotating motor between each car giving it the ability to twist.

6. The robotic tree cutter as in claim 2 wherein said car-like units further includes arch-shaped boxes capable of wrapping around the tree; and
said car-like units capable of driving on wheels turned by worm drive motors;
said wheels including at least two wheels one on each side of one or more of said car-like units, such that they are located on a front, rear position or middle position of each car-like unit.

7. The robotic tree cutter as in claim 2 wherein said string of car-like units is in a snake like configuration such that it is configured to mimic the motions of a snake.

8. The robotic tree cutter as in claim 2 wherein said chainsaw is configured to avoid jamming by including a chainsaw bar that has rollers embedded in it driven by flat gears in the metal.

9. The robotic tree cutter as in claim 2 wherein said computerized remote control device is configured to include computer readable instructions executed by one or more processors in an electronic controller, the computer readable instructions being configured to control said robotic tree cutter.

10. The robotic tree cutter as in claim 9 wherein as said computer readable instructions are configured to activate the motors and actuators on the robotic tree cutter, including the speed of the saw, the actions of the robotic arm, and the actions of the car-like units.

11. The robotic tree cutter as in claim 10 wherein said actions of the robotic arm and the car-like units include actions controlled by the remote control and/or by autonomous software.

12. The robotic tree cutter as in claim 11 wherein said autonomous software is driven by sonar sensors mounted to at least one of the front of the front car-like unit and the top of the front car-like unit and on the rear car-like unit.

13. The robotic tree cutter as in claim 2 wherein said robotic arm is configured to hold the saw and move the saw;
said robotic arm including a rotating collar that wraps around the first car-like unit; and
said robotic arm including a rotating turret that holds a hinge, all actuated by electric motors and gears.

14. The robotic tree cutter as in claim 2 wherein the branch deflecting rollers further include at least two rollers coupled to or mounted from top to bottom on the front of the string of car-like units, such that they are arranged to turn in opposite directions in order to force the robotic tree cutter away from any obstructing branches.

15. A tree climbing apparatus comprising:
a head segment with a centerline having a propulsion unit for engaging a tree and providing propulsion in the direction of the centerline of the head segment;
a series of body segments and a tail segment serially connected behind the head segment;
a series of segment joints connecting the head segment to a following body segment, connecting subsequent body segments to each other, and connecting the tail segment to a last body segment; and
a joint control system for resiliently positioning the head, body and tail segments in a generally serpentine gripping position around the tree, the propulsion unit of the head segment in combination with the joint control system for propelling the tree climbing apparatus up the tree with the head segment moving in the direction of the centerline of the head segment, with the body and tail segments following in a generally serpentine manner.

16. The tree climbing apparatus of claim 15 further comprising a saw attached to the head segment.

17. The tree climbing apparatus of claim 16 in which the propulsion unit includes drive wheels and the body and tail segments include rollable wheels, for engaging a tree.

18. The tree climbing apparatus of claim 15 in which the joints include springs which allow at least one of bending of the segments relative to each other, movement towards and away from each other.

19. The tree climbing apparatus of claim 15 further comprising a spring loaded cable system for providing the segments with a generally serpentine resilient gripping ability.

20. (canceled)
